(19) United States
(12) Patent Application Publication
(10) Pub. No.: US 2017/0264724 A1
(43) Pub. Date: Sep. 14, 2017

(54) MAGNETICALLY ALIGNED HANDSET

(71) Applicant: Polycom, Inc., San Jose, CA (US)

(72) Inventor: Sandeep Parimal, Hyderabad (IN)

(21) Appl. No.: 15/068,994

(22) Filed: Mar. 14, 2016

(51) Int. Cl. H04M 1/10

(52) U.S. Cl. CPC H04M 1/10

(57) ABSTRACT

A communication device includes a magnetically aligning handset. In an embodiment, an alignment element in the handset magnetically couples with a corresponding alignment element in a cradle portion when the handset is in an on-hook position. The handset engages a hookswitch on the cradle portion of the communication device while in the on-hook position. When the hookswitch is engaged, the handset is not active for communication. The magnetic alignment elements may assist in guiding the handset into the on-hook position and may secure the handset against inadvertent disturbances to the off-hook position. Each alignment element may include a number of magnetic regions and non-magnetic regions, selected to align the handset in a particular orientation within the cradle.

### BACKGROUND

The present disclosure relates generally to telecommunication systems, and more particularly, to a telecommunication device having a magnetically aligned handset.

Desktop telephones typically include a handset having a speaker and a microphone for communicating sound and voice via a telecommunications network. The handset speaker and microphone become active when the handset is “off-hook”, indicated by the disengagement of a hookswitch, and are inactive when the handset is “on-hook”, indicated by the engagement of the hookswitch. The hookswitch is located on the cradle of the telephone that supports the handset when not in use.

When returned to the cradle, the handset does not always seat in the on-hook position and securely engage the hookswitch. In addition, even if the hookswitch is successfully engaged by the handset, the handset may be particularly susceptible to jostling off-hook if not securely placed within the cradle in the on-hook position.

### SUMMARY

A telecommunication device is disclosed having a handset that magnetically aligns within a receiving cradle to engage a hookswitch. At least one magnetic alignment element is included in the handset, positioned to magnetically mate with at least one corresponding magnetic alignment element in the receiving cradle of the telecommunication device. The magnetic alignment elements are positioned within each of the handset and the cradle so that the hookswitch is engaged when the corresponding magnetic alignment elements are mated.

In one aspect, the magnetic alignment elements guide a handset placed within the telecommunication device's receiving cradle to engage the hookswitch. For example, a user may place the handset in the vicinity of the cradle during a hang-up action. As the handset approaches the cradle, the magnetic alignment element in the handset becomes increasingly magnetically attracted to the magnetic alignment element in the cradle. At some distance, the magnetic attraction between alignment elements snaps the handset into place within the cradle, mating the magnetic alignment elements and engaging the hookswitch. The magnetic alignment elements may allow a user to feel that the handset is placed in the on-hook position without looking to confirm.

In another aspect, the magnetic alignment elements secure the handset in an on-hook position, maintaining engagement of the hookswitch. For example, the strength of the magnetic alignment elements may be selected so as to reliably secure the handset in the on-hook position within the cradle, e.g. on a wall-mounted phone. In another example, the magnetic alignment elements reduce the risk of inadvertent disengagement of the handset from the on-hook position due to bumping or jostling, for example, within a small, busy, or cluttered desktop workspace, while easily releasing the handset from the cradle when picked up by a user.

### BRIEF DESCRIPTION OF THE DRAWINGS

FIG. 1A illustrates a top-down view of a telecommunication device having a magnetically-aligned handset, according to an embodiment of the invention.

FIG. 1B illustrates a side perspective view of a telecommunication device having a magnetically-aligned handset, according to an embodiment of the invention.

FIG. 2A illustrates a handset having a magnetic alignment element, according to an embodiment of the invention.

FIG. 2B illustrates a cradle portion of a telecommunication device having a magnetic alignment element, according to an embodiment of the invention.

FIG. 3A illustrates a handset having a magnetic alignment element, according to an embodiment of the invention.

FIG. 3B illustrates a cradle portion of a telecommunication device having a magnetic alignment element, according to an embodiment of the invention.

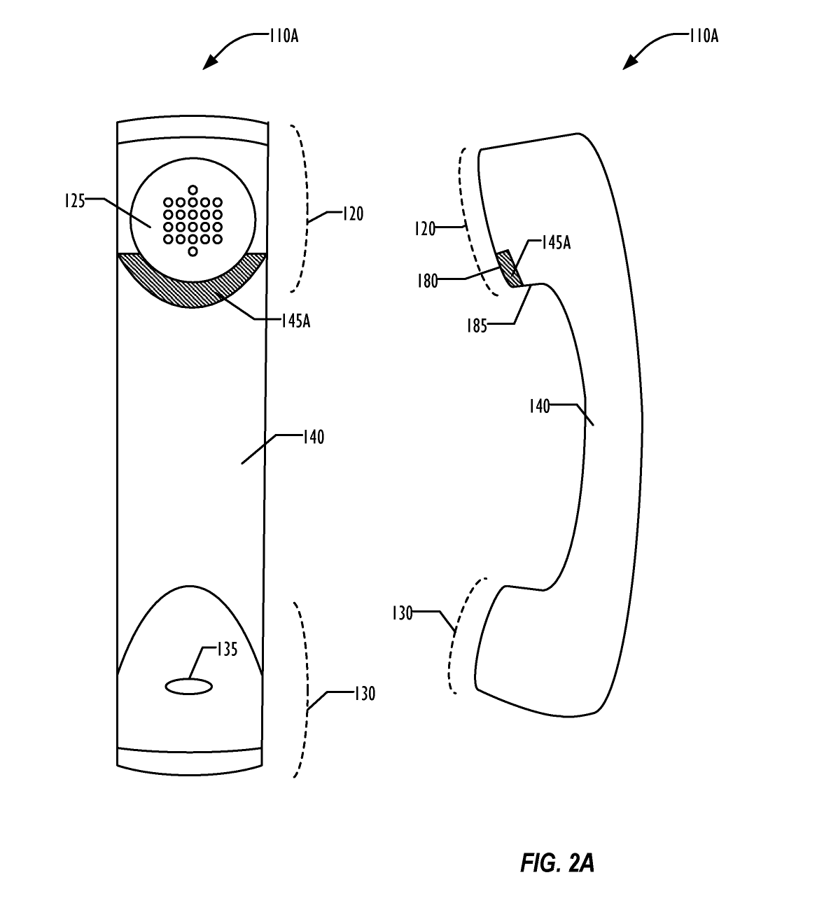

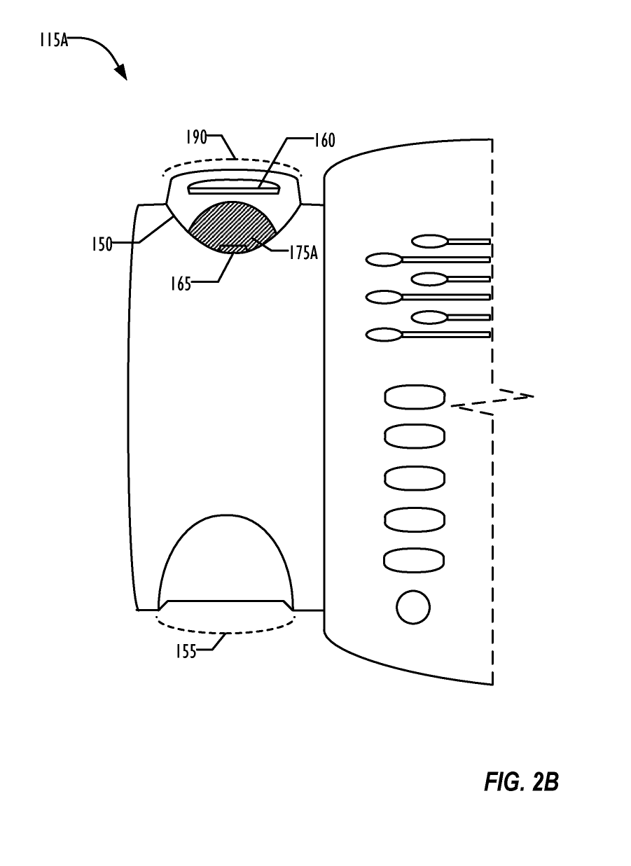

FIG. 2A illustrates a handset having two magnetic alignment elements, according to an embodiment of the invention.

FIG. 4B illustrates a cradle portion of a telecommunication device having a magnetic alignment element, according to an embodiment of the invention.

FIG. 5A illustrates a handset having a magnetic alignment element within the microphone portion of the handset, according to an embodiment of the invention.

FIG. 5B illustrates a handset having a magnetic alignment element within the microphone receiver portion of the handset, according to an embodiment of the invention.

FIG. 6A illustrates a handset having a magnetic alignment element, according to an embodiment of the invention.

FIG. 6B illustrates a cradle portion of a telecommunication device having a magnetic alignment element and not having a physical hookswitch, according to an embodiment of the invention.

### DETAILED DESCRIPTION

The following description is made for the purpose of general illustration and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

For purposes of describing the embodiments disclosed herein, two elements are considered to be coupled when one element is able to send an electrical signal to another element. The electrical signal may represent, for example but not limited to, data, operating commands, status information, or electrical power, or any combination of these electrical signals. A coupling may be implemented by wired or wireless connection means.

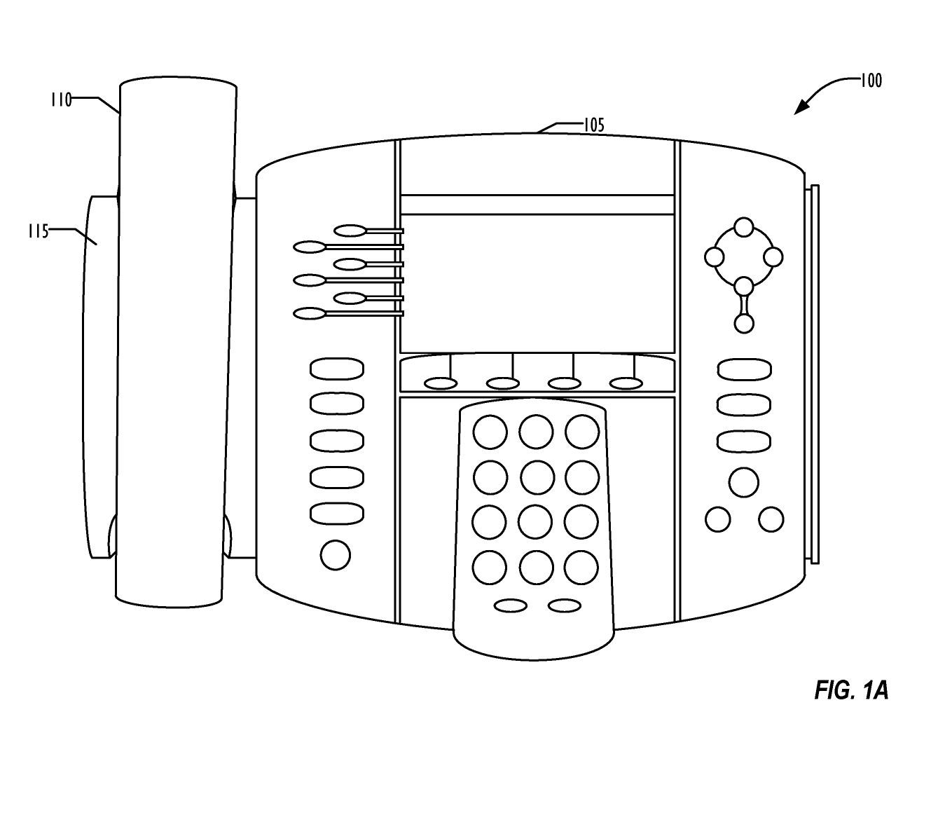

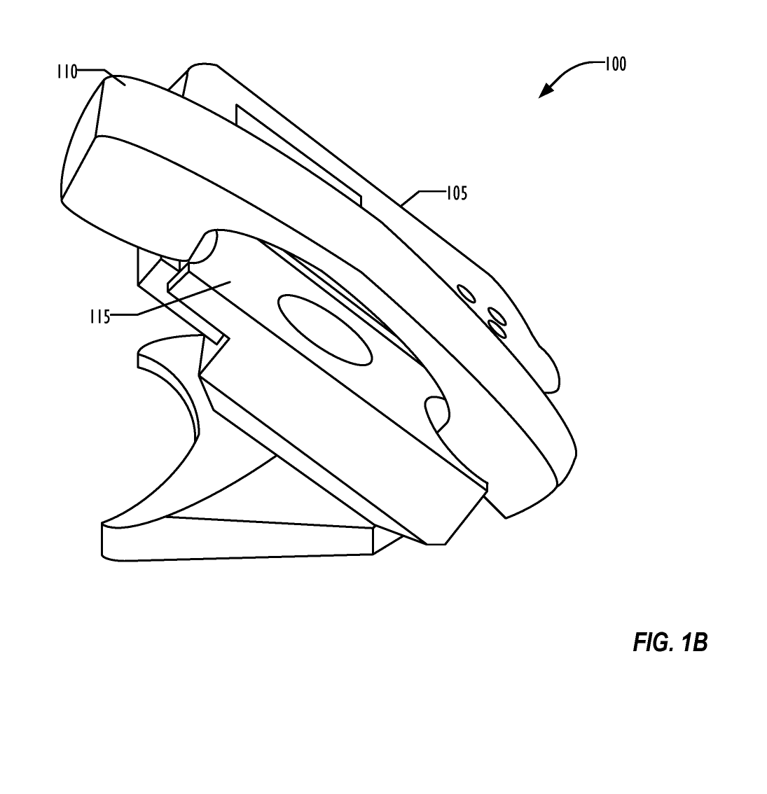

FIG. 1A illustrates a communication system 100, having a main body 105, a cradle portion 115, and a magnetically aligned handset 110, according to an embodiment of the invention. Main body 105 may include input elements for receiving user input, such as dialing a phone number, and/or output elements for displaying output, such as identification information associated with an incoming call. In an embodiment, main body 105 is coupled to a network to enable communication with other devices coupled to the network.

The cradle portion 115 of the main body 105 of communication system 100 supports handset 110 in the on-hook position, according to an embodiment. FIG. 1B illustrates a side perspective view of communication system 100. Handset no is shown in FIGS. 1A and 1B in the on-hook position. Cradle portion 115 may include a hookswitch (not shown), which when engaged disables the handset 110 (i.e. when the handset 110 is in the on-hook position), and when disengaged activates the handset 110 (i.e. when the handset 110 is in the off-hook position). Handset no may communicate an audio signal to and from main body 105 wirelessly or through a wire (not shown).

Communication system 100 is illustrated as a desktop telephone, but may be any communication device including a handset that engages a hookswitch in an on-hook position. In addition, the input and output elements may have a variety of configurations, including hard and soft keys/buttons. Furthermore, input and output elements may be located on the cradle or handset portions of the communication device.

FIGS. 2A and 2B illustrate a handset 110A and cradle portion 115A having corresponding magnetic alignment elements, according to an embodiment of the invention. As illustrated in FIG. 2A, handset 110A includes a speaker portion 120 and microphone portion 130 connected by a handle portion 140, according to an embodiment. Speaker portion 120 includes a speaker 125 and has a front face 180 and lower surface 185, according to an embodiment. Microphone portion 130 includes a microphone 135. As will be generally understood, a user of a communication device may hold handset 110A so that he can hear a communicated audio signal produced by speaker 125 and speak into microphone 135.

As illustrated in FIG. 2B, cradle portion 115A includes a cradle ledge 150, a speaker portion receiver 190, a microphone portion receiver 155, a hookswitch 160, and a hookswitch tab 165, according to an embodiment of the invention. Speaker portion receiver 190 is recessed to receive speaker portion 120 when the handset 110A is in the on-hook position. Cradle ledge 150 projects so as to engage lower surface 185 when handset 110A is in the on-hook position. In an embodiment, cradle ledge 150 defines the bottom edge of speaker portion receiver 190. In an embodiment, a hookswitch tab receiver (not shown) within lower surface 185 of handset 110A engages the hookswitch tab 165 when handset 110A is in the on-hook position. Microphone portion receiver 155 may be recessed to receive the microphone portion 130 of handset 110A when the handset 110A is in the on-hook position, according to an embodiment.

The engagement of hookswitch 160 determines whether handset 110A is active, according to an embodiment. When handset 110A is in the on-hook position, hookswitch 160 is engaged. When handset 110A is in the off-hook position, hookswitch 160 is not engaged. In an embodiment, hookswitch 160 is a physical switch that is depressed by the speaker portion 120 of handset 110A when handset 110A is in the on-hook position. In another embodiment, hookswitch 160 is an electrical contact that forms an electrical connection with a corresponding contact on handset 110A when handset 110A is in the on-hook position.

Handset 110A includes a magnetic alignment element 145A, according to an embodiment. The magnetic alignment element 145A in handset 110A may magnetically couple to corresponding magnetic alignment element 175A in cradle portion 115A. In an embodiment, the magnetic alignment elements 145A/175A guide the handset 110A into a position within the cradle portion 115 that engages the hookswitch 160, reducing the risk of the handset 110A being inadvertently placed or moved into an off-hook position when in the vicinity of the cradle portion 115A.

In an embodiment, magnetic alignment element 145A is located on a front face 180 of speaker portion 120. In an embodiment, a corresponding magnetic alignment element 175A is located within speaker portion receiver 190, so as to magnetically couple with the portion of front face 180 containing the magnetic alignment element 145A. Location of the alignment element 175A in proximity to hookswitch 160 assists in aligning and securing the handset 110A so as to engage the hookswitch 160 in an on-hook position. However, alignment elements may be located in other portions of the cradle portion and handset, so long as they result in positioning the handset to engage the hookswitch. Furthermore, though one alignment element is shown in each of handset 110A and cradle portion 115A, additional corresponding pairs of alignment elements may be located within the handset and cradle portion.

As used herein, “magnetic material” indicates a material that either produces a magnetic field (i.e., a permanent magnet) or does not produce a magnetic field but is magnetically attracted to an external magnetic field. In one embodiment, each of magnetic alignment elements 145A and 175A includes a permanent magnet having polarities selected so that magnetic alignment elements 145A/175A magnetically couple when handset 110A is in the on-hook position on cradle portion 115A. In another embodiment, one of magnetic alignment elements 145A and 175A does not include a permanent magnet, but includes a material that is magnetically attracted to a permanent magnet. For example, a material having a random magnetic polarization in the absence of an external magnetic field may be used for one of the magnetic alignment elements 145A/175A.

Magnetic materials include iron-based materials (e.g. ferrite and alnico) and rare earth metal-based materials (e.g. neodymium and samarium-cobalt). Rare earth metal-based magnets, such as neodymium iron-based materials, are preferred for the strength of the magnetic field they produce, however, more conventional magnetic materials can be used. For example, steel varieties are generally low cost and enable shape flexibility.

Magnetic alignment elements 145A and 175A may have a fully magnetic surface, meaning that the full surface area is available for magnetic coupling by being either a permanent magnet or a material magnetically attracted to a permanent magnet. In another embodiment, magnetic elements 145A and 175A may have one or more magnetic regions and one or more non-magnetic regions, which are regions containing neither a permanent magnet nor a material magnetically responsive to a permanent magnet. By tailoring the size, position, and number of the magnetic regions within each of the magnetic alignment elements 145A/175A, the precision of the alignment of the handset 115A within the cradle portion 115A may be tailored.

For example, where magnetic alignment element 175A is fully magnetic and magnetic alignment element 145A includes a small magnetic region within a large non-magnetic region, handset 110A may be magnetically engaged in any orientation where the small magnetic region of magnetic alignment element 145A overlaps with the area of magnetic alignment element 175A. However, where both magnetic alignment element 145A and 175A include a small magnetic region within a large non-magnetic region, handset 110A will magnetically engage only in the orientation where the two small magnetic regions precisely align.

The components of each of magnetic alignment elements 145A and 175A may be directly exposed, or one or both may be encased within handset 110A or cradle portion 115A, respectively. For example, handset 110A may have a plastic outer casing, with the magnetic alignment element 145A located within the outer casing. In another embodiment, magnetic element 175 is located within a plastic casing forming cradle portion 115A. That is, one or more layers of material unrelated to the magnetic alignment of the handset may be disposed between magnetic alignment element 145A and corresponding magnetic alignment element 175A when the magnetic alignment elements are coupled. In another embodiment, magnetic alignment elements 145A and 175A are in direct contact when magnetically coupled.

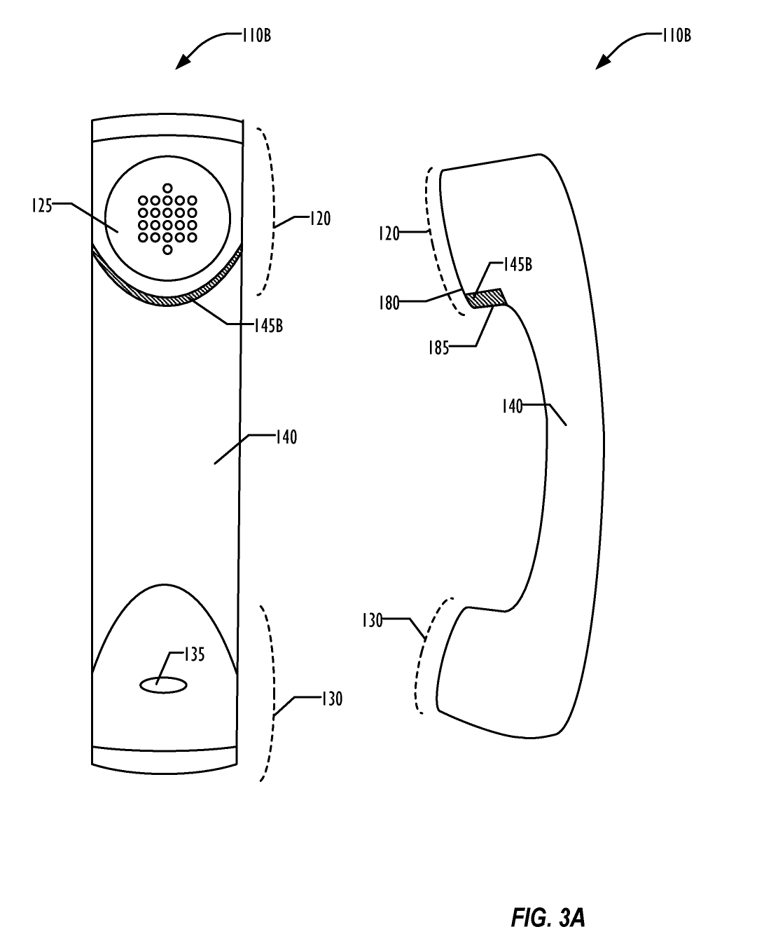

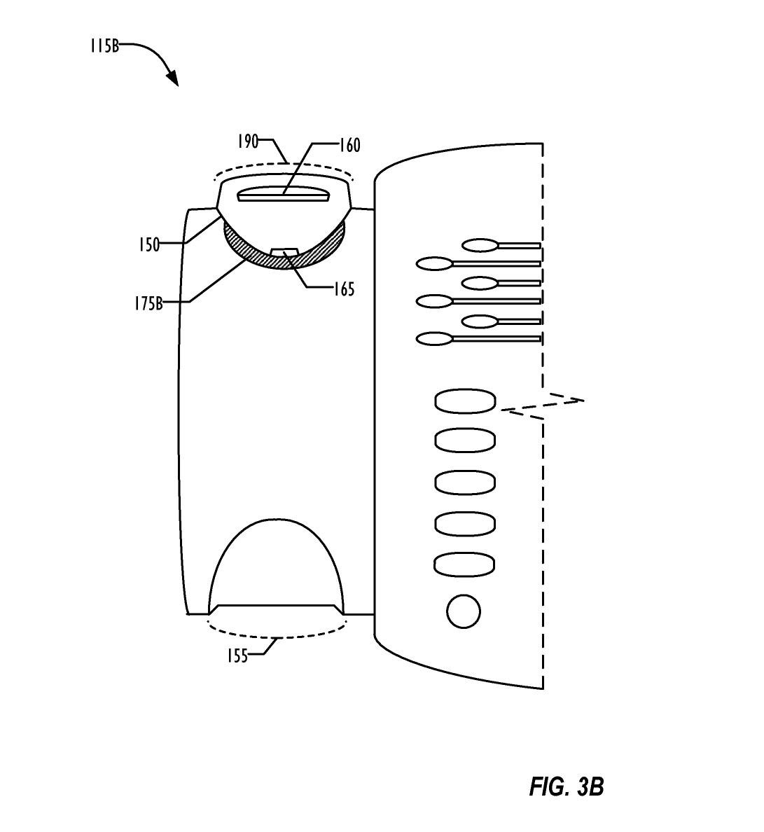

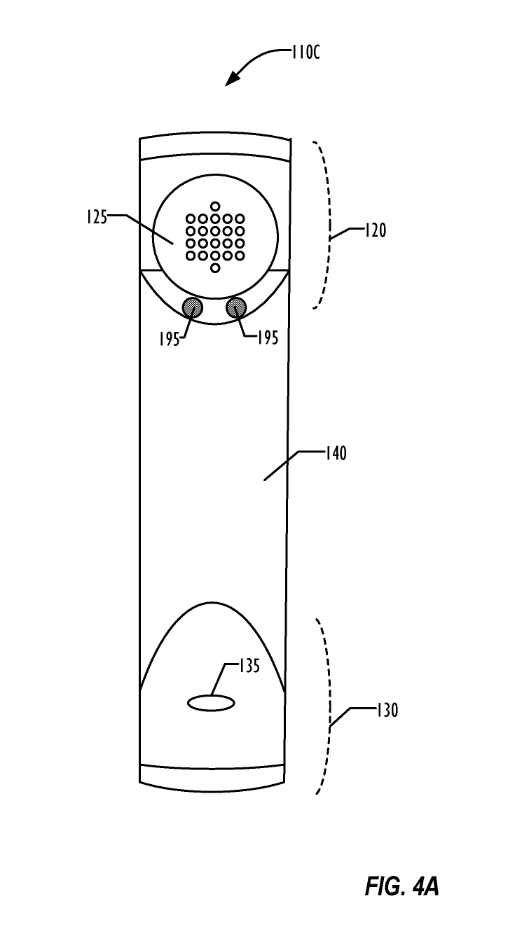

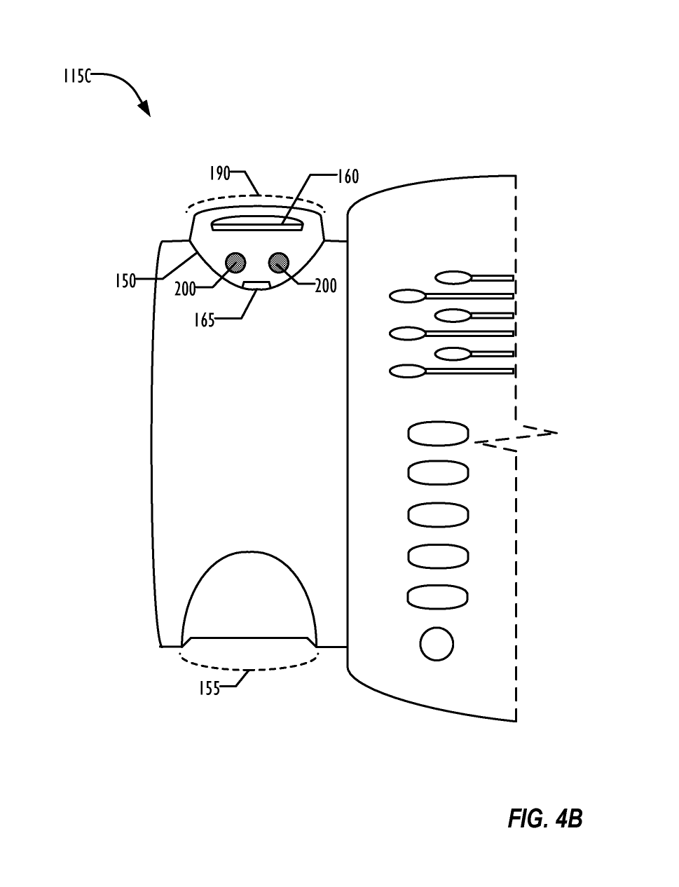

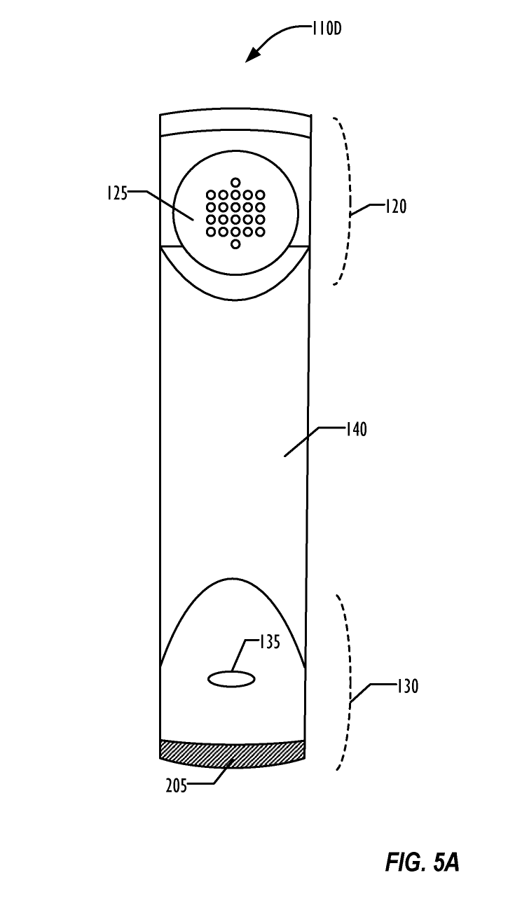

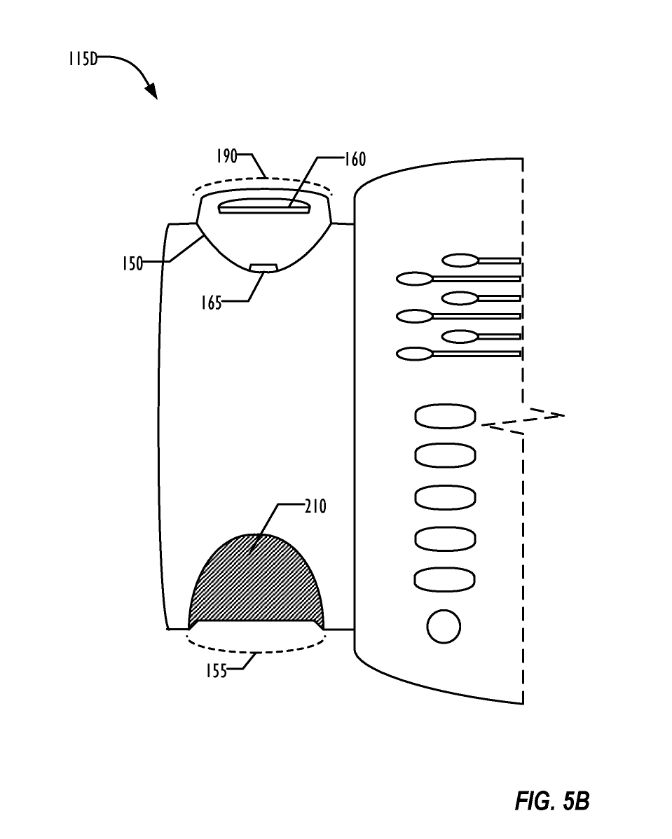

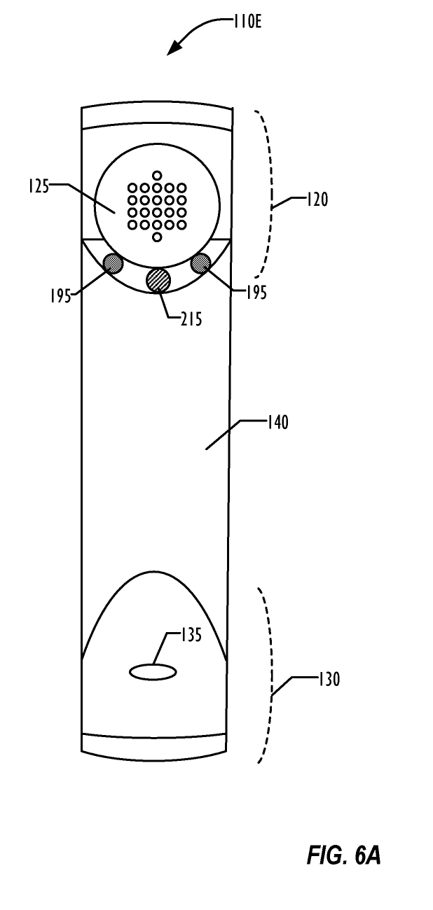

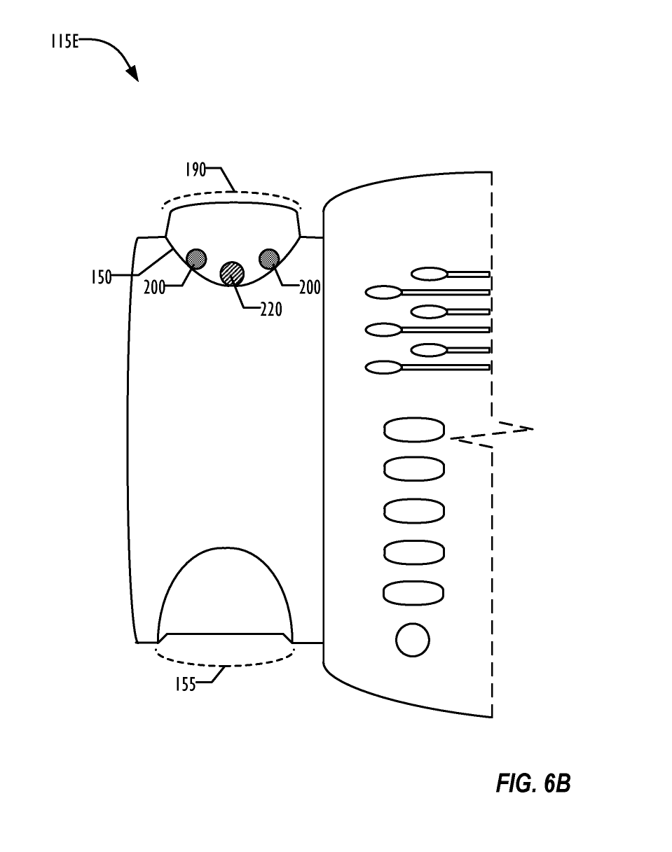

FIGS. 3A and 3B illustrate a handset 110B and cradle portion 115B having corresponding magnetic alignment elements, according to an embodiment of the invention. Handset 110B includes magnetic alignment element 145B, according to an embodiment. Magnetic alignment element 145B encompasses a portion of lower surface 185 of speaker portion 120. Cradle portion 115B includes magnetic alignment region 175B, according to an embodiment. Magnetic alignment element 175B encompasses a portion of cradle ledge 150, on which lower surface 185 of headset 110B rests while in the on-hook position. As such, when handle 110B is placed in the on-hook position with respect to cradle portion 115B, magnetic alignment elements 145B and 175B magnetically couple, securing handset 110B and engaging hookswitch 160 within cradle portion 115B. As described above with respect to magnetic alignment elements 145A and 175A, magnetic alignment elements 145B and 175B may include a variety of arrangements of non-magnetic materials and regions in addition to magnetic materials and regions.

FIGS. 4A and 4B illustrate a handset 110C and cradle 115B, each having two magnetic alignment elements, according to an embodiment of the invention. Each of magnetic alignment elements 195 in handset 110C and magnetic alignment elements 200 in cradle 115B may include magnetic materials as discussed above. In an embodiment, magnetic alignment elements 195 are common round magnets are affixed within round recesses in the speaker portion 120. Similarly, magnetic alignment elements 200 may be common round magnets affixed within round recesses in speaker portion receiver 190. When handset 110C is placed on cradle 115C, each magnetic element 195 magnetically couples with a corresponding magnetic element 200. The two corresponding magnetic elements 195/200 assist in the alignment of handset 110C within cradle 115C. For example, having at least two magnetically coupled points prevents rotational misalignment that may be permitted by a single magnetic coupling. It is to be understood that magnetic elements 195 and 200 may vary in size, shape, and arrangement.

In another embodiment, handset 110C is placed within a cradle having a single larger magnetic alignment element, such as cradle 115A in FIG. 2B. The larger magnetic element 175A may be a steel plate, which magnetically couples to handset 110C via permanent magnetic alignment elements 195 in handset 110C. In yet another embodiment, cradle 115C receives a handset having a single larger magnetic alignment element, such as handset 110A in FIG. 2A. This embodiment allows the use of a low-cost steel plate in handset 110A, which is not permanently magnetized, along with low-cost round magnetic alignment elements in the cradle 115C. Having permanent magnets in the cradle portion and a steel plate (which is not permanently magnetized) in the handset avoids the situation where a permanent magnet in the handset interferes with the user (e.g., with a hearing aid or earring).

FIGS. 5A and 5B illustrate a handset 110D and cradle 115D having magnetic alignment elements in the microphone portion and microphone receiver portions, respectively, according to an embodiment of the invention. In an embodiment, handset 110D includes magnetic alignment element 205 within microphone portion 130. In an embodiment, cradle portion 115D includes magnetic alignment element 210 within microphone receiver portion 155. The magnetic coupling of magnetic alignment elements 205/210 align handset 110D in the on-hook position so that hookswitch 160 is engaged. In addition, magnetic alignment elements 205/210 may secure handset 110D within cradle portion 115D. Magnetic alignment elements 205 and 210 may be in addition to or in lieu of magnetic alignment elements (not shown) in other portions of the handset, such as within speaker portion 120. Where magnetic alignment elements 205 and 210 are in addition to other magnetic elements, alignment may be improved by reducing the risk of rotation of handset 110D with respect to cradle portion 115D, as may be permitted by a single pair of magnetic alignment elements. It is to be understood that magnetic alignment elements 205 and 210 may vary in size, shape, and location within the microphone portion and microphone portion receiver, respectively.

It is to be understood that though the magnetic alignment elements are illustrated with respect to a particular handset design, any handset and cradle portion designs including a handset that engages a hookswitch when placed in an on-hook position may be magnetically aligned using the magnetic alignment elements disclosed herein. Additionally, magnetic alignment elements may encompass larger or smaller areas than those illustrated in FIGS. 2A-5. It is to be understood that the precise location and orientation of magnetic alignment elements with respect to each of a handset and a corresponding cradle will depend on the design and geometry of the handset and cradle.

FIGS. 6A and 6B illustrate a handset 110E and cradle 115E, respectively, where the cradle does not have a physical hookswitch, according to an embodiment of the invention. In the place of a physical hookswitch, a phone device may include a proximity sensor. A proximity sensor detects the proximity of a nearby object without physical contact. Proximity sensors may include capacitive, photoelectric, inductive, or magnetic mechanisms. As used for a hookswitch, a proximity sensor detects the proximity of the handset to the cradle, indicating that the handset is in the on-hook position.

Handset 110E includes a proximity element 215 and two magnetic alignment elements 195, according to an embodiment. Cradle 115E includes a proximity element 220 and two magnetic alignment elements 200, according to an embodiment. When proximity element 215 is within sufficient proximity to proximity element 220, the proximity switch is engaged; that is, the handset is in the on-hook position. In an embodiment, magnetic alignment elements 195 and 200 are attracted by a magnetic force sufficient to align and hold the handset 110E in a position relative to cradle 115E so that proximity elements 215 and 220 are engaged.

In an embodiment, proximity element 220 is a proximity switch. Proximity element 220 may be, for example, a reed switch. A reed switch operates by engaging or disengaging when an external magnetic field is applied. As such, proximity element 215 may be a magnetic element that triggers reed switch 220. In another embodiment, proximity element 215 is a proximity sensor, such as a reed switch. In this case, proximity element 220 is a magnetic element that triggers reed switch 215. Other types of proximity switches may be used. In an embodiment, only one proximity element is required—in either the cradle or the handset—which detects the presence of the handset within the cradle. Other configurations of one or more magnetic alignment elements are possible, including, but not limited to, magnetic alignment elements in the microphone portion of the handset and the microphone receiver portion of the cradle, as described above with respect to FIGS. 5A and 5B.

Those skilled in the art will appreciate that various adaptations and modifications can be configured without departing from the scope and spirit of the embodiments described herein. Therefore, it is to be understood that, within the scope of the appended claims, the embodiments of the invention may be practiced other than as specifically described herein.

1. A communication device, comprising:
a handset having a first magnetic alignment element; and
a body, the body including a cradle portion capable of receiving the handset and a hookswitch located in the cradle portion, wherein the cradle portion includes a second magnetic alignment element that magnetically couples with the first magnetic alignment element to engage the hookswitch and wherein the magnetic coupling of the first magnetic alignment element and the second magnetic alignment element aligns the handset within the cradle portion.

2. The communication device of claim 1, wherein the magnetic coupling of the first magnetic alignment element and the second magnetic alignment element secures the handset within the cradle portion.

3. The communication device of claim 1, wherein the first magnetic alignment element is located in a speaker portion of the handset.

4. The communication device of claim 1, wherein the second magnetic alignment element is located within a cradle ledge of the cradle.

5. The communication device of claim 1, wherein at least one of the first magnetic alignment element and second magnetic alignment element includes one or more non-magnetic regions and one or more magnetic regions.

6. The communication device of claim 1, further comprising:
a hookswitch tab coupled to the cradle;
a hookswitch tab receiver within the handset, wherein the magnetic coupling of the first magnetic alignment element and the second magnetic alignment element aligns the hookswitch tab within the hookswitch tab receiver.

7. The communication device of claim 1, wherein the hookswitch is a physical hookswitch.

8. The communication device of claim 1, wherein the hookswitch is a proximity hookswitch.

9. The communication device of claim 1, wherein at least one of the first alignment element and second magnetic alignment element comprises a permanent magnet.

10. The communication device of claim 9, wherein the permanent magnet comprises a ferromagnetic material.

11. The communication device of claim 9, wherein the permanent magnet comprises a rare-earth metal.

12. The communication device of claim 1, wherein the permanent magnet comprises neodymium.

13. The communication device of claim 1, further comprising one or more materials disposed between the first magnetic alignment element and second magnetic alignment element when the first magnetic alignment element and second magnetic alignment element are magnetically coupled.

14. The communication device of claim 1, wherein the handset further comprises a third magnetic alignment element and the cradle further comprises a fourth magnetic alignment element that magnetically couples with the third magnetic alignment element.

15. The communication device of claim 14, wherein the handset further comprises a microphone portion, and wherein the microphone portion comprises the third magnetic alignment element.

16. The communication device of claim 1, wherein the handset further comprises a microphone portion, and wherein the microphone portion comprises the first magnetic alignment element.

17. A communication device, comprising:
a handset having a speaker portion and a microphone portion, wherein the speaker portion includes a first magnetic alignment element capable of magnetically coupling with a second magnetic alignment element to engage a hookswitch in a cradle portion of a body and to align the handset within the cradle portion.

18. The communication device of claim 17, further comprising the body.

19. A communication device, comprising:
a body, the body including a cradle portion capable of receiving a handset and a hookswitch located in the cradle portion, wherein the cradle portion includes a second magnetic alignment element that magnetically couples with a first magnetic alignment element in the handset to engage the hookswitch and to align the handset within the cradle portion.

20. The communication device of claim 19, further comprising the handset.
